(19) United States
(12) Patent Application Publication
(10) Pub. No.: US 2026/0265527 A1
(43) Pub. Date: Sep. 10, 2026

(54) ALTERNATIVE SOLVENT SYSTEMS AND DYE FORMULATIONS

(71) Applicants: Milliken & Company, Spartanburg, SC (US); Milliken Industrials Limited, Wigan Lancashire (GB); Milliken Europe BV, Gent (BE)

(72) Inventors: Alex Foster, Wigan Lancashire (GB); Laurent De Bruyne, Gentbrugge (BE); Jimmy Maxwell Stokes, Spartanburg, SC (US)

(21) Appl. No.: 19/558,050

(22) Filed: Mar. 5, 2026

Related U.S. Application Data
(60) Provisional application No. 63/768,427, filed on Mar. 7, 2025.

(51) Int. Cl. C09B 33/044; C09B 1/16; C09B 3/78; C09B 31/062; C09B 31/143; C09B 33/12; C09B 33/16

(52) U.S. Cl. CPC C09B 33/044; C09B 1/16; C09B 3/78; C09B 31/062; C09B 31/143; C09B 33/12; C09B 33/16

(57) ABSTRACT

Compositions, formulations, methods, kits, and uses for organic solvent dyes. The compositions and dye formulations include at least a dye compound and a solvent. The compositions and dye formulations may optionally further include cosolvents, additives, reaction byproducts, and other components. The compositions and formulations may be useful in, for example, producing colored smoke for aerial displays, non-destructive testing, coloring a substrate, and tagging a substrate for identification. The compositions and dye formulations provide less hazardous, more environmentally friendly alternatives with good performance relative to conventional dye formulations.

### CROSS-REFERENCE TO RELATED APPLICATIONS

None.

### TECHNICAL FIELD

The present invention concerns solvent systems for solvent dye formulations, the dye formulations themselves, and methods, applications, kits, and uses thereof.

### BACKGROUND OF THE INVENTION

The present invention relates to dye formulations that include solvent dyes in less hazardous solvent systems than conventional, petroleum-based solvents.

Dye formulations or colorants have widespread commercial uses. Solvent dyes have become commercially popular due to their high tinctorial strength (i.e., the amount of color per unit colorant) and ease of handling at the point of application. As defined in Hawley's Condensed Chemical Dictionary, Eleventh Edition, solvent dyes are organosoluble dyes. Thus, the term solvent dyes includes liquid and powder dyes, as the word “solvent” merely indicates that solvent dyes are dissolvable in organic solvent.

In isolation, solvent dyes generally are in powder form or have a tar-like consistency at room temperature. Thus, viscosity depressant solvent systems are used to dilute these solvent dyes for manufacturing commercially viable dye formulations that may function for applications requiring flow of the solvent dyes.

Those of ordinary skill in the art will know that a dye is a substance that imparts color when dissolved or mixed in or applied to a substrate (i.e., the product that is dyed). Solvent dyes are soluble in a variety of substrates but insoluble in water. Some of the substrates they are used to color are organic solvents, hydrocarbon fuels, waxes, lubricants and plastics. Solvent dye molecules are typically nonpolar or of minimal polarity, and they do not undergo ionization.

Historically, xylene (mixed and single isomers), high flash aromatic solvents, hydro-treated light and middle naphthenic distillates, and hydro-treated mineral oils have been the solvents of choice for oil soluble applications (e.g., petroleum-based applications). For non-petroleum applications, alcohols, straight and branched chain, glycols, glycol ethers, mineral spirits, soy oil esters, and NMP (i.e., N-Methyl Pyrrolidone) have been the solvents of choice. Many of the aforementioned solvent systems present workers and consumers exposure problems due to their toxicity profile. Similarly, many of these solvents may have undesirable environmental impacts. In the case of soy oil esters, which have been presented more recently as a more environmentally friendly, less hazardous alternative to these other solvents, cost and performance can present an issue.

Dye formulations have typically used solvents that are amenable to their end use application. An example of this is C.I. Solvent Red 164 diluted with mineral oil. This mixture is sold as Navipol Red 164 HF, available from the Sunbelt Corporation, Rock Hill, South Carolina, USA, as well as under other commercial brands. One of its principal uses is the coloration of automotive transmission fluid (i.e., substrate) to detect leaks in automobile transmissions. In this case, mineral oil is the solvent of choice due to its likeness to the substrate (transmission fluid) and its compatibility with automotive gaskets and seals.

Similarly, viscosity depressant solvents are chosen based on their usefulness for a specific end use application and their acceptable solubility and liquid stability in the relevant dye formulation. Thus, toxicity as well as impact on the environment has been secondary to functionality in this context, as well. As a specific end use application example in this context, C.I. Solvent Red 164 is also frequently diluted with Aromatic 200 naphthalene depleted (sold, for instance, under the Automate™ Red 9BHF Liquid Dye brand, available from Dow, Inc., Midland, MI) and used in coloration of decorative and safety smoke for air shows or aerobatic displays and other maneuvers. In such applications, dye formulations are often fed directly into the exhaust of a jet in flight from a tank that is usually retrofitted to an aircraft (the “jet efflux” method of smoke generation). When the dye formulation is fed into the jet exhaust stream, the rapid increase in temperature drives evaporation of any solvent in the dye formulation and sublimation of the dye/colorant itself to provide colored smoke. Planes may also be equipped with on-board smoke generators that do not rely on an aircraft's exhaust system to generate smoke, but rather generate and emit smoke by evaporating solvent and sublimating the dye of a dye formulation in a contained, separate system. Exemplary such on-board smoke generator systems include the SCSG-5 and Smokewinder models, available from Sanders Smoke Technologies, Inc., lone, California, USA. Thus, solvents for such applications must be volatile enough to evaporate when exposed to heat, but not so volatile as to ignite. Dye compounds must be capable of sublimating. High color strength of dye formulations is also important to this application, as vibrant colors are needed for aerial displays, and lower-concentration dye formulations must be fed at a greater flow rate to achieve a desired vibrancy. The greater flow rate leads to shorter smoke display time due to limited tank space. Thus, higher-concentration dye formulations are generally preferred. However, increasing dye concentration in a dye formulation comes with a resulting increase in dye formulation viscosity. Thus, suitable solvent systems must also provide adequate solubility to yield acceptable color strength without an unacceptable increase in viscosity that would degrade performance in the smoke generation system. High flash petroleum-based solvents have conventionally been used as solvent systems for this application given their good solubility for a range of dyes, good viscosity profile at relatively high dye concentration, and their favorable evaporation and flash points.

Recently, however, there has been greater emphasis on manufacturing environmentally friendly dye formulations. Environmental programs such as REACH (i.e., Registration, Evaluation, Authorization and Restriction of Chemicals) are being implemented in the European Union. One of the mandates of the REACH program is for chemical manufacturers to systematically replace products containing chemicals that are toxic and harmful to the environment with less toxic products manufactured using improved “greener” technology.

In view of the aforementioned, a need exists for solvents and solvent systems that are useful in specific end use applications (e.g., have acceptable solubility and liquid stability or viscosity profiles for existing commercially available dyes, with good evaporation and flashpoint profiles) but are also environmentally safe and less toxic, all while providing favorable cost profiles for customers.

### SUMMARY OF THE INVENTION

In a first aspect, the present invention provides a dye formulation including a dye compound or a mixture of dye compounds, as defined throughout the specification, and a solvent, as defined throughout the specification. The dye formulation may further optionally include at least one of cosolvents, additives, reaction byproducts, or other suitable components.

In a second aspect, the present invention provides a dye formulation consisting essentially of a dye compound or a mixture of dye compounds, as defined throughout the specification, and a solvent, as defined throughout the specification, and may further optionally consist essentially of at least one of cosolvents, additives, or reaction byproducts.

In yet another aspect, the present invention provides the present dye formulation for use: as a colorant for producing colored smoke in aerial displays; liquid penetrant for conducting liquid penetrant testing for non-destructive testing; or as a tagging colorant for tagging a substrate for identification.

In yet another aspect, the present invention provides kits including components including dye compound or a mixture of dye compounds, as defined throughout the specification, and a solvent, as defined throughout the specification. Said kits may further optionally include cosolvents, additives, reaction byproducts, or other suitable components.

In yet another aspect, the present invention provides a method for generating colored smokes for aerobatic displays, using the presently disclosed dye formulation.

In yet another aspect, the present invention provides a method of coloring a substrate using the presently disclosed dye formulation.

In yet another aspect, the present invention provides a method of using the presently disclosed dye formulation for tagging substrates.

In yet another aspect, the present invention provides a surface coated with the presently disclosed dye formulation.

The foregoing, as well as other objectives and advantages of the present invention and the manner in which the same are accomplished, are further specified within the following detailed description and appended claims.

### DETAILED DESCRIPTION OF THE INVENTION

In a first embodiment, the invention provides a dye formulation including a dye compound and a solvent. The dye formulation may optionally further comprise one or more of cosolvents, additives, and reaction byproducts.

### Solvent

The solvents used in the present dye formulations replace in whole or in significant part traditional solvent systems for solvent dyes. For petroleum/oil soluble applications the inventive solvents replace, in whole or in part, conventional solvents such as, but not limited to, xylene (mixed and single isomers), high flash aromatic solvents and hydro-treated light and middle naphthenic distillates. For non-petroleum based applications, the inventive solvents replace, in whole or in part, conventional solvents such as, but not limited to, alcohols (straight and branched chain), limonene, mineral spirits, vegetable oil esters, and NMP. As compared to the aforementioned traditional solvent systems, the inventive solvents are less toxic and more environmentally friendly and meet proposed and existing regulations in both the United States and the European Union.

In exemplary embodiments, the inventive solvents are of Formula I:

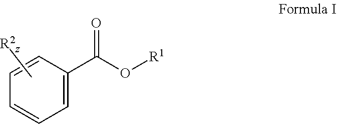

wherein R¹ is a C₁ to C₆ alkyl group; R² is F, Cl, Br, C₁₋₄-alkyl, —NH—CO—H, —NH—CO—C₁₋₄alkyl, —NH₂, —NH—C₁₋₄-alkyl, or NO₂; and z is 0, 1, 2, 3, or 4.

In further exemplary embodiments, the inventive solvents are of Formula II:

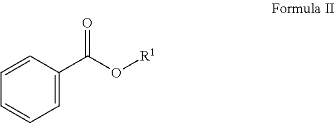

wherein R¹ is a C₁ to C₆ alkyl group.

In some exemplary embodiments, the solvent is selected from the group consisting of methyl benzoate, ethyl benzoate, isopropyl benzoate, propyl benzoate, butyl benzoate, isopentyl benzoate, and mixtures thereof. In a preferred embodiment, the solvent is ethyl benzoate.

In preferred embodiments, the inventive solvents, along with any cosolvents, described further below, are present in the dye formulation in an amount sufficient to dilute the dye compound(s) to a liquid consistency. Further, the inventive solvents, along with any cosolvents, are present in the dye formulation in an amount sufficient to keep the toxic levels of the dye formulation within the currently proposed and existing regulations in the United States (e.g., EPA regulations) as well as in European Union (e.g., REACH regulations).

In some embodiments, the inventive solvent is present in the dye formulation in an amount of at least about 10 wt. %, in further embodiments, at least about 20 wt. %, in yet further embodiments, at least about 25 wt. %, in still further embodiments at least about 30 wt. %, and in still further embodiments at least about 35 wt. %. In some embodiments, the inventive solvent is present in the dye formulation in an amount of at most about 77 wt. %, in further embodiments, at most about 75 wt. %, in yet further embodiments, at most about 70 wt. %, in still further embodiments at most about 60 wt. %, and in still further embodiments at most about 40 wt. %.

In preferred embodiments, the inventive solvent has a flash point of at least 65° C., in further embodiments, at least 70° C., and in still further embodiments, at least 75° C. Unless the context clearly indicates otherwise, all flash point measures are indicated according to the open cup method at standard pressure (1 ATM).

### Dye Compound

Dye compounds suitable for the present invention include, in some embodiments, any solvent dyes that are capable of forming a liquid consistency in the inventive solvents disclosed herein.

In some embodiments, the dye compounds are selected from the group consisting of compounds of Formulas A, B, C, D, E, F, G, and mixtures thereof:

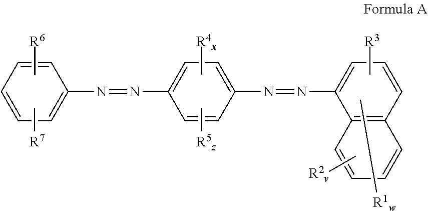

wherein R¹_{w} and R²ᵥ are each independently a C₆ to C₁₁ alkyl group; R³ is selected from hydroxyl and —NHR⁸, and any R⁸ is a C₇ to C₁₄ alkyl group; R⁴ₓ and R⁵_{z} is each independently a C₁ to C₄ alkyl group; R⁶ and R⁷ is each independently selected from hydrogen or a C₁ to C₄ alkyl group; each of v, w, x, and z may be 0 or 1; x+z≥1; and if w+v=0, R³ is —NHR⁸, and any R⁸ is a C₇ to C₁₄ alkyl group;

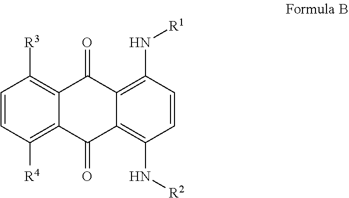

wherein each of R¹ and R² is independently selected from the group consisting of C₁ to C₁₂ alkyl and —C₁-C₅—O—C₁-C₁₂; each R³ and R⁴ is independently H or hydroxyl; and at least one of R¹ and R² contains five or more carbon atoms;

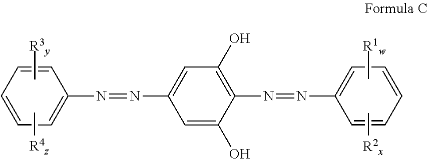

wherein each of R¹_{w} and R²ₓ is independently a C₇ to C₁₄ alkyl group; each of R³_{y} and R⁴_{z} is independently a C₁ to C₁₄ alkyl group; each of w, x, y, and z may be 0 or 1, and w+x+y+z≥2

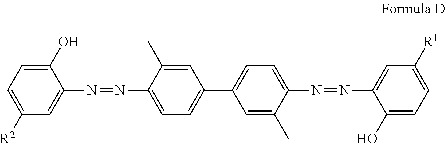

wherein each of R¹ and R² is independently a C₇ to C₁₅ alkyl group;

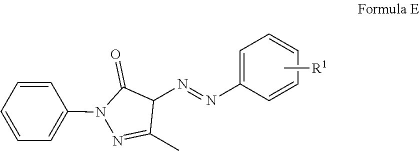

wherein R¹ is a C₇ to C₁₅ alkyl group;

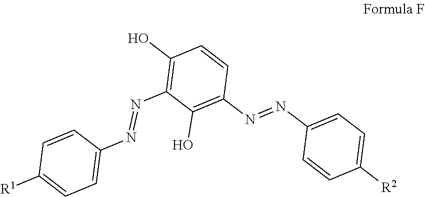

wherein R¹ and R² are each independently a C₇ to C₁₅ alkyl group; and

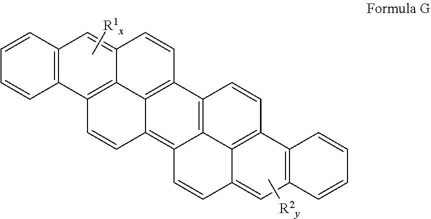

wherein R¹ₓ and R²_{y} are each independently a C₇ to C₁₅ alkyl group; x and y may each be 0 or 1 and x+y≥1.

In further exemplary embodiments, the dye compound is selected from the group consisting of C.I. Solvent Red 164 (4-(phenylazo)-benzamine and mono-tetramethylated derivatives diazotized and coupled to alkylated 2-Naphthalenol), C.I. Solvent Red 164:1 (manufactured without o-toluidene), C.I. Solvent Red 165 (C.I. Red 164 shaded with C.I. Solvent Orange 98), C.I. Solvent Red 19(T) (mix of 1-[[2-methyl-4-[(2-methylphenyl)azo]phenyl]azo]-N-alkylnaphthalen-2-amines and 1-({2-methyl-4-[(2-methylphenyl)diazenyl]phenyl}diazenyl)-2-naphthol), C.I. Solvent Red 19(E) (N-(2-ethylhexyl)-1-({2-methyl-4-[(2-methylphenyl)diazenyl]phenyl}diazenyl)-1,2-dihydronaphthalen-2-amine), C.I. Solvent Red 175 (Dinaptho[1,2,3,-cd:1′,2′,3′-Im]perylene-9,18-dione,dodecyl derivatives), C.I. Solvent Blue 98 (9,10-Anthracenedione, 1,4-Mixed Alkyl-Amino), C.I. Solvent Blue 79 (9,10-Anthracenedione, 1,4-Mixed Alkyl-Alkoxy Amino), C.I. Solvent Yellow 175 (4-[((di)alkyl phenyl) diazenyl]-2-[((di)alkyl phenyl) diazenyl]benzene-1,3-diol and derivatives), C.I. Solvent Yellow CAS no. 97660-72-5 (3H-Pyrazol-3-one, 2,4-dihydro-5-methyl-2-phenyl-, 4-[(alkylphenyl)azo]derivatives), C.I. Solvent Yellow 107 (2,2′-((3,3′-Dialkyl(1,1′-biphenyl)-4,4′-diyl)bis(azo))bis(4-alkylphenols)), C.I. Solvent Orange 98 (1,3-Benzenediol, 2,4-bis(alkylphenyl-azo)), C.I. Solvent Blue 99 (2-methoxy-5-methyl-4-{phenyl-azo}-benzamine diazotized and azo coupled to N-(alkylphenyl)-2 naphthalenamine), C.I. Solvent Red ((4-(phenyl-azo)-benzamine and mono-tetramethylated derivatives diazotized and coupled to N-(2-ethyl-hexyl)-2-naphthalenamine)), C.I. Solvent Red ((2-Naphthaleneamine-N-2-(ethyl-hexyl-1-{{2-methylphenylazo}-phenyl}azo} and mixtures thereof), C.I. Solvent Green 33 (9,10-Anthracenedione-1,4-(dodecylphenyl)), and mixtures thereof.

In some exemplary embodiments, the dye compound is selected from the group consisting of C.I. Solvent Red 164 (4-(phenylazo)-benzamine and mono-tetramethylated derivatives diazotized and coupled to alkylated 2-Naphthalenol), C.I. Solvent Red 164:1 (manufactured without o-toluidene), C.I. Solvent Red 165 (C.I. Red 164 shaded with C.I. Solvent Orange 98), C.I. Solvent Red 19(T) (mix of 1-[[2-methyl-4-[(2-methylphenyl)azo]phenyl]azo]-N-alkylnaphthalen-2-amines and 1-({2-methyl-4-[(2-methylphenyl)diazenyl]phenyl}diazenyl)-2-naphthol), C.I. Solvent Red 19(E) (N-(2-ethylhexyl)-1-({2-methyl-4-[(2-methylphenyl)diazenyl]phenyl}diazenyl)-1,2-dihydronaphthalen-2-amine), C.I. Solvent Red 175 (Dinaptho[1,2,3,-cd:1′,2′,3′-Im]perylene-9,18-dione,dodecyl derivatives), C.I. Solvent Blue 98 (9,10-Anthracenedione, 1,4-Mixed Alkyl-Amino), C.I. Solvent Blue 79 (9,10-Anthracenedione, 1,4-Mixed Alkyl-Alkoxy Amino), C.I. Solvent Yellow 175 (4-[((di)alkyl phenyl) diazenyl]-2-[((di)alkyl phenyl) diazenyl]benzene-1,3-diol and derivatives), C.I. Solvent Yellow CAS no. 97660-72-5 (3H-Pyrazol-3-one, 2,4-dihydro-5-methyl-2-phenyl-, 4-[(alkylphenyl)azo]derivatives), C.I. Solvent Yellow 107 (2,2′-((3,3′-Dialkyl(1,1′-biphenyl)-4,4′-diyl)bis(azo))bis(4-alkylphenols)), C.I. Solvent Orange 98 (1,3-Benzenediol, 2,4-bis(alkylphenyl-azo)), and mixtures thereof.

In further embodiments, the dye compound is present in the dye formulation in an amount of at least about 23 wt. %, in yet further embodiments, at least about 25 wt. %, in still further embodiments at least about 30 wt. %, and in still further embodiments at least about 35 wt. %. In some embodiments, the dye compound is present in the dye formulation in an amount of at most about 50 wt. %, in further embodiments, at most about 55 wt. %, in yet further embodiments, at most about 60 wt. %, and in still further embodiments at most about 65 wt. %.

### Cosolvents

In some embodiments, the dye formulation includes cosolvents in addition to the solvent.

In embodiments, such cosolvents may include a dibasic ester or a mix of dibasic esters.

In preferred embodiments, such cosolvents may include dibasic esters of formula III:

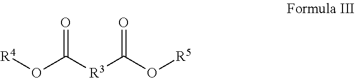

wherein R³ is a C₁ to C₅ dienyl group; and R⁴ and R⁵ are each independently a C₁ to C₄ alkyl group.

Exemplary dibasic esters of Formula III include dimethyl glutarate, dimethyl adipate, and dimethyl succinate, and mixtures thereof. One exemplary mixture of dimethyl glutarate, dimethyl adipate, and dimethyl succinate is available commercially as FlexaTrac DME-100 from Ascend Performance Materials, Houston, Texas, USA.

In some embodiments, cosolvents may further include conventional solvents, such as xylenes (mixed and single isomers), high flash aromatic solvents, hydro-treated light and middle naphthenic distillates, hydro-treated mineral oils, alcohols (straight and branched chain), glycols, glycol ethers, mineral spirits, soy oil esters, and NMP (i.e., N-Methyl Pyrrolidone).

In further preferred embodiments, the cosolvent comprises an aryl benzoate of Formula IV:

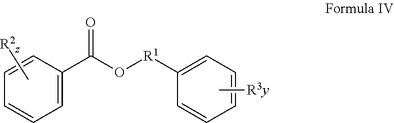

wherein R¹ is a C₁ to C₄ alkyl group;
R² is F, Cl, Br, C₁₋₄-alkyl, —NH—CO—H, —NH—CO—C₁₋₄alkyl, —NH₂, —NH—C₁₋₄alkyl, or NO₂ and z is 0, 1, 2, 3, or 4; and
R³ is F, Cl, Br, C₁₋₄-alkyl, —NH—CO—H, —NH—CO—C₁₋₄alkyl, —NH₂, —NH—C₁₋₄alkyl, or NO₂ and y is 0, 1, 2, 3, or 4.

In some further preferred embodiments, aryl benzoate is selected from the group consisting of benzyl benzoate, phenethyl benzoate, and mixtures thereof.

In preferred embodiments, when present, the cosolvent has a flash point of at least 65° C., in further embodiments, at least 70° C., and in still further embodiments, at least 75° C.

In some embodiments less than 0.09 wt. % cosolvent is present in the inventive dye formulation. In further embodiments, the cosolvent is present in the dye formulation in an amount of at least about 0.1 wt. %, in further embodiments, at least about 2 wt. %, in yet further embodiments, at least about 5 wt. %, in still further embodiments at least about 7 wt. %, and in still further embodiments at least about 10 wt. %. In some embodiments, the cosolvent is present in the dye formulation in an amount of at most about 35 wt. %, in further embodiments, at most about 30 wt. %, in yet further embodiments, at most about 25 wt. %, in still further embodiments at most about 20 wt. %, and in still further embodiments at most about 12 wt. %.

In further embodiments, the dye formulations of the present invention are substantially free of certain conventional solvents, such as xylenes (mixed and single isomers), high flash aromatic solvents, hydro-treated light and middle naphthenic distillates, hydro-treated mineral oils, alcohols (straight and branched chain), glycols, glycol ethers, mineral spirits, soy oil esters, and NMP. By “substantially free of” is meant herein that the dye formulation or relevant composition contains less than 1 wt. % of the referenced material.

In further embodiments, the dye formulations of the present invention are substantially free of xylenes (mixed and single isomers), high flash aromatic solvents, hydro-treated light and middle naphthenic distillates, and hydro-treated mineral oils.

In further embodiments, the dye formulations of the present invention contain no more than 10 wt. % of the sum of any xylenes (mixed and single isomers), high flash aromatic solvents, hydro-treated light and middle naphthenic distillates, and hydro-treated mineral oils.

In further embodiments, the dye formulations of the present invention contain no more than 5 wt. % of the sum of any xylenes (mixed and single isomers), high flash aromatic solvents, hydro-treated light and middle naphthenic distillates, and hydro-treated mineral oils.

### Additives and Reaction Byproducts

In some embodiments, the dye formulations of the present invention may further include one or more of additives and reaction byproducts.

Exemplary additives, when present, include one or more of surfactants, dispersants, and any other suitable additive typically used in dye formulations. Exemplary surfactants include Span® 60 (CAS No. 1338-41-6), Span® 85 (CAS No. 26266-58-0), Tween® 60 (CAS No. 9005-67-8), Tween® 85 (CAS No. 9005-70-3) (each available from Millipore Sigma). Exemplary dispersants include Solsperse™ 24000 (non-aqueous, polymeric dispersant; available from the Lubrizol Corporation), Crodabond™ CSA (hydrogenated castor oil/sebacic acid copolymer; available from Croda International Plc), OleoCraft™ HP-31 (polyamide-3; available from Croda International Plc), and Dertoline MG 130 (glycerol ester of maleic rosin; CAS No. 68038-41-5; available from Alfa Chemistry).

In some embodiments, additives are present in the inventive dye formulations in an amount of no more than 10 wt. %, in further embodiments, no more than 5 wt. %, and further embodiments, no more than 2 wt. %, in yet further embodiments, no more than 1 wt. %, and in still yet further embodiments, no more than 0.1 wt. %.

As used herein, “photosensitive polymer” refers to a polymeric material (including but not limited to resins) that is suitable for photolithography and/or pattern-forming commonly used in display electronics. For the avoidance of doubt, the dye compounds disclosed herein are not photosensitive polymers.

In preferred embodiments, the inventive dye formulations are substantially free of any photosensitive polymer. In further preferred embodiments, the inventive dye formulations include no more than 0.1 wt. % photosensitive polymer, and in still further embodiments, no more than 0.01 wt. % photosensitive polymer. Most preferably, the dye compositions disclosed herein are entirely free of any photosensitive polymers (no detectable photosensitive polymers).

As used herein, “reaction byproducts” refer to compounds that are produced in the production of or a reaction forming dye compounds. Such reaction byproducts are structurally distinct from the dye compounds disclosed herein, but are incidental to the production of said dye compounds and thus are often included alongside the dye compounds.

In preferred embodiments, reaction byproducts are present in the inventive dye formulations in an amount of no more than 15 wt. %, in further embodiments, no more than 10 wt. %, and further embodiments, no more than 5 wt. %, and in yet further embodiments, no more than 2 wt. %.

### Dye Formulations and Uses, Kits, and Methods

In some preferred embodiments, the dye formulations of the present invention have a viscosity at 20±1° C. and standard pressure (1 ATM) of from 10 to 50 centipoise. Unless stated otherwise, all viscosity measures provided in this disclosure are indicated at 20±1° C. and standard pressure (1 ATM), and viscosity measurements are conducted on a digital viscometer and measured at 50 RPM. A person of ordinary skill in the art will be able to select the appropriate spindle size for a given sample material and may, for example, select an 18 mm spindle, a 34 mm spindle, or other appropriate spindle. In preferred embodiments, the viscosity of the disclosed dye formulations is at least 5 centipoise, in further embodiments, at least 10 centipoise, in still further embodiments, at least 15 centipoise, and in yet further embodiments, at least 20 centipoise. In preferred embodiments, the viscosity of the disclosed dye formulations is at most 30 centipoise, in further embodiments, at most 50 centipoise, in still further embodiments, at most 60 centipoise, and in yet further embodiments, at most 80 centipoise.

In some further embodiments, the viscosity of the disclosed dye formulations is at least 5 centipoise and at most 500 centipoise. In some further embodiments, the viscosity of the disclosed dye formulations is at least 5 centipoise and at most 450 centipoise. In yet further embodiments, the viscosity of the disclosed dye formulations is at least 5 centipoise and at most 415 centipoise.

In some preferred embodiments, the dye formulations of the present invention provide a favorable viscosity increase profile with decreasing temperature. Unless stated otherwise, as used herein, the “standardized viscosity increase” of a dye formulation refers to the difference between the viscosity of a dye formulation at 25±1° C. and standard pressure (1 ATM) and the viscosity of the same dye formulation at 5±1° C. and standard pressure (1 ATM) in centipoise. Unless otherwise stated, each such viscosity measure is conducted on a digital viscometer, and the 25±1° C. measurement is made at 50 RPM while the 5±1° C. measurement is made at 10 RPM. A person of ordinary skill in the art will be able to select the appropriate spindle size for a given sample material and may, for example, select an 18 mm spindle, a 34 mm spindle, or other appropriate spindle. In preferred embodiments, the standardized viscosity increase of the disclosed dye formulations is at most 40 centipoise, in further embodiments, at most 50 centipoise, in still further embodiments, at most 75 centipoise, and in yet further embodiments, at most 120 centipoise.

In some embodiments, the invention is a dye formulation as disclosed herein for use in producing colored smoke for aerial or aerobatic displays. In such embodiments, said dye formulations are useful for jet efflux and self-contained, on-board smoke generators. The dye formulations of said embodiments may be fed directly into the exhaust of a jet in flight from a tank that is retrofitted to an aircraft (the “jet efflux” method of smoke generation). When the dye formulation is fed into the jet exhaust stream, the rapid increase in temperature drives evaporation of any solvent in the dye formulation and sublimation of the dye/colorant itself to provide colored smoke. The dye formulations may also be added to on-board smoke generators that do not rely on an aircraft's exhaust system to generate smoke, but rather generate and emit smoke by evaporating solvent and sublimating the dye of a dye formulation in a contained, separate system (the “self-contained, on-board smoke generator” method). Exemplary such on-board smoke generator systems include the SCSG-5 and Smokewinder models, available from Sanders Smoke Technologies, Inc., lone, California, USA. The dye formulations disclosed according to these embodiments are volatile enough to evaporate when exposed to heat, but not so volatile as to ignite. The inventive dye formulations permit high solubility of dye compounds and thus higher color strength and greater available smoke display time, all while maintaining a usable (flowable) viscosity profile. The dye formulations of the present invention are further less hazardous to pre-flight prep crew, post-flight cleanup and maintenance crews, and any other person handling said dye formulations. They are also more environmentally friendly.

In some embodiments, the invention is a dye formulation as disclosed herein for use in conducting liquid penetrant testing for non-destructive testing. Liquid penetrant testing (LPT) is a widely utilized non-destructive testing (NDT) method employed to detect surface-breaking defects in non-porous materials. In such testing, a dye formulation as disclosed herein, acting as a liquid penetrant, is applied to a surface of a test material, allowing the dye formulation to seep into any discontinuities. The dye formulation may be applied directly as a liquid or as a component of an aerosol. After a suitable dwell time, the dye formulation is removed (the surface may be cleaned), and the remaining dye formulation marks any defects. The remaining dye formulation may be treated with a developer chemical that draws out any penetrating dye formulation to better mark a defect. Such embodiments are effective for identifying cracks, porosity, and other surface anomalies in metals, ceramics, and plastics, and ensuring the integrity and reliability of critical components without causing damage. In alternative testing methods, dye formulation can be analogously used to indicate leaks in a container (e.g. a reaction vessel). The dye formulation for use in liquid penetrant testing has a favorable (flowable) viscosity profile at relatively low temperatures sometimes required by applicators (down to 10 or even zero ° C.) when marking outside surfaces or surfaces in refrigerated environments.

In yet another embodiment, the present invention is a surface coated with the dye formulation disclosed herein.

In some embodiments, the invention comprises a kit for providing a dye formulation, wherein the kit includes a first component, wherein the first component comprises an inventive solvent according to any inventive solvent embodiment described above, and a second component, wherein the second component comprises a dye compound according to any dye compound embodiment described above. The kit for providing a dye formulation may further comprise one or more of a cosolvent or an additive according to any embodiment of each of the cosolvent or additive, as described above. Each of any cosolvent or additive may be present in the first component, the second component, or a third component of the kit, or more than one of said components. The kit according to the invention may further comprise reaction byproducts as further described above. Each such reaction byproduct, if present, will typically be present in the second component with a corresponding dye compound. It will also be appreciated in view of the considerations outlined above, that the first, second, and any third components of the described kit embodiments are physically separated (for instance in separate cartridges, sachets, pouches, tanks, or the like). The components of such kits are generally combined with one another, whereby to provide a dye formulation in accordance with the invention.

In some embodiments, the invention comprises a kit for providing a dye formulation used in liquid penetrant testing for non-destructive testing, wherein the kit includes a first component, wherein the first component comprises an inventive solvent according to any inventive solvent embodiment described above and a dye compound according to any dye compound embodiment described above, and a second component, wherein the second component comprises a developer chemical for drawing out the first component from a surface defect on a surface. The kit for providing a dye formulation may further comprise one or more of a cosolvent or an additive according to any embodiment of each of the cosolvent or additive, as described above. Each of any cosolvent or additive may be further present in the first component or the second component of the kit, or more than one of said components. The kit according to the invention may further comprise reaction byproducts as further described above. Each such reaction byproduct, if present, will typically be present in the first component with a corresponding dye compound. It will also be appreciated in view of the considerations outlined above, that the first and second components of the described kit embodiments are physically separated (for instance in separate cartridges, sachets, pouches, tanks, or the like). The components of such kits are generally combined with one another, whereby to provide materials useful for non-destructive testing of a material surface.

Some embodiments are directed to a method of contacting the various components of a given inventive kit. There is no particular order in which the contacting of the methods need be carried out, though for kits including a second component including a chemical developer, it will typically be preferrable that the first component be applied to a test surface prior to combination with the second component. The kits of the invention may optionally comprise instructions or other guidance as to methods according to which the various components may be contacted. In this way, the manufacturer of the dye compounds, solvents, and kits can provide guidance to sellers or end-users of dye formulations as to which solvents, dye compounds, and optional cosolvents and additives to use and which optimal dosing can be used for a given application.

In some embodiments, the invention provides a method of using the inventive dye formulation for coloring of various substrates (e.g., coloring of automatic transmission fluid to detect leaks in automobile transmissions and coloring of heating oil to differentiate between on-road fuels subject to excise taxes and heating oil and other classes deemed to be tax exempt).

In another embodiment, the present invention is a method of tagging substrates using the dye formulation that includes solvent dyes dissolved in inventive solvent systems as described herein. U.S. Pat. Nos. 5,737,871 and 5,156,653 disclose the need for tagging organic liquids, particularly petroleum fuel. The disclosures of both these patents are incorporated herein by reference. Organic liquids, particularly petroleum fuels, are tagged for identification purposes, such as, tax purposes (e.g., road fuel vs. agriculture fuel), product brand identification, and quality control (e.g., octane identification). In many cases, particularly brand identification, tagging helps to identify dilution of a tagged fuel with non-tagged fuel.

The dye formulation of the present invention is used to tag by mixing specific quantities of the dye formulation (i.e., a dye compound dissolved in solvent) into a pre-determined amount of substrate to be tagged. The amounts of dye formulation and the substrate used for this purpose are such that the presence of the dye formulation can be easily detected as and when required for identification of the tagged substrate. For example, substrates may be tagged with about 2-200 PPM of the dye formulation of the present invention.

Typically, the substrates that are tagged by the aforementioned method include (but are not limited to) gasoline, heating oil, kerosene, stove oil, #2-cycle oil, diesel fuel, paraffin wax, and solvents (e.g., toluene, xylene, isooctane).

Whenever the term “substituted” is used herein, it is meant to indicate that one or more hydrogens on the atom indicated in the expression using “substituted” is replaced with a selection from the indicated group, provided that the indicated atom's normal valency is not exceeded, and that the substitution results in a chemically stable compound, i.e., a compound that is sufficiently robust to survive isolation from a reaction mixture. Where the indicated group is not specified, a person having ordinary skill in the art will be able to select viable substituents that are suitable for the application in question, given the benefit of this disclosure.

Unless the context clearly indicates otherwise: the word “and” indicates the conjunctive; the word “or” indicates the disjunctive; when the article is phrased in the disjunctive, followed by the words “or both” or “combinations thereof” both the conjunctive and disjunctive are intended.

As used in this application, the terms “approximately” and “about” indicate values within 10% of the stated value, except where noted or context dictates otherwise.

As used herein, “alkyl” will mean linear and branched, saturated hydrocarbon monovalent groups; unless context dictates otherwise, said alkyl group may further optionally include one or more suitable substituents independently selected from the group consisting of amino, halogen, hydroxy, sulfhydryl, haloalkyl, alkoxy and the like.

Each and every patent and non-patent reference referred to herein is hereby incorporated by reference in its entirety, as if the entire content of each reference was set forth herein in its entirety.

The invention may be further understood with reference to the following non-nonlimiting clauses:

Clause 1. A composition comprising:
(i) a solvent having Formula I;

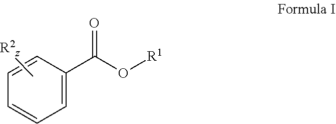

wherein R¹ is a C₁ to C₆ alkyl group; R² is F, Cl, Br, C₁₋₄-alkyl, —NH—CO—H, —NH—CO—C₁₋₄alkyl, —NH₂, —NH—C₁₋₄alkyl, or NO₂; and z is 0, 1, 2, 3, or 4; and
(ii) a dye compound selected from the group consisting of compounds of formulas A, B, C, D, E, F, and G and mixtures thereof:

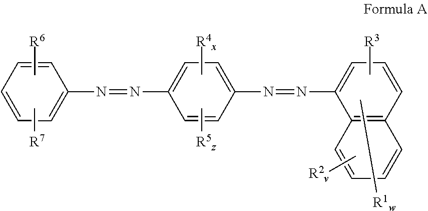

wherein R¹_{w} and R²ᵥ are each independently a C₆ to C₁₁ alkyl group; R³ is selected from hydroxyl and —NHR⁸, and any R⁸ is a C₇ to C₁₄ alkyl group; R⁴ₓ and R⁵_{z} is each independently a C₁ to C₄ alkyl group; R⁶ and R⁷ is each independently selected from hydrogen or a C₁ to C₄ alkyl group; each of v, w, x, and z may be 0 or 1; x+z>1; and if w+v=0, R³ is —NHR⁸, and any R⁸ is a C₇ to C₁₄ alkyl group;

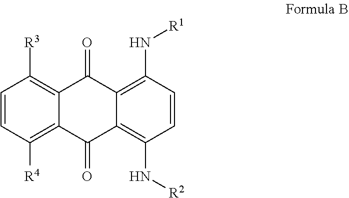

wherein each of R¹ and R² is independently selected from the group consisting of C₁ to C₁₂ alkyl and —C₁-C₅—O—C₁-C₁₂; each R³ and R⁴ is independently H or hydroxyl; and at least one of R¹ and R² contains five or more carbon atoms;

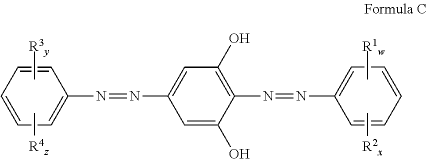

wherein each of R¹_{w} and R²ₓ is independently a C₇ to C₁₄ alkyl group; each of R³_{y} and R⁴_{z} is independently a C₁ to C₁₄ alkyl group; each of w, x, y, and z may be 0 or 1, and w+x+y+z≥2;

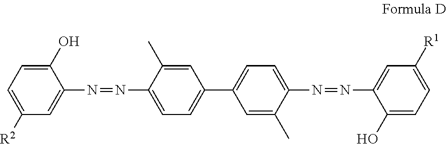

wherein each of R¹ and R² is independently a C₇ to C₁₅ alkyl group;

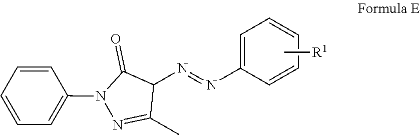

wherein R¹ is a C₇ to C₁₅ alkyl group;

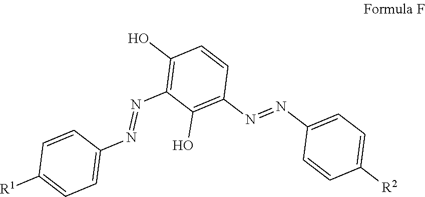

wherein R¹ and R² are each independently a C₇ to C₁₅ alkyl group; and

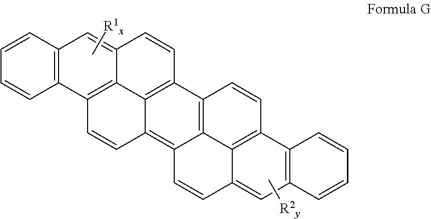

wherein R¹ₓ and R²_{y} are each independently a C₇ to C₁₅ alkyl group; x and y may each be 0 or 1 and x+y 1.

Clause 2. The composition of Clause 1, wherein the solvent is of Formula II:

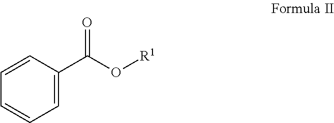

wherein R¹ is C₁ to C₆ alkyl.

Clause 3. The composition of any preceding clause, wherein the solvent is selected from the group consisting of methyl benzoate, ethyl benzoate, isopropyl benzoate, propyl benzoate, butyl benzoate, isopentyl benzoate, and mixtures thereof.

Clause 4. The composition of any preceding clause, wherein the solvent is ethyl benzoate.

Clause 5. The composition of any preceding clause, wherein the dye compound is selected from the group consisting of: C.I. Solvent Red 164 (4-(phenylazo)-benzamine and mono-tetramethylated derivatives diazotized and coupled to alkylated 2-Naphthalenol), C.I. Solvent Red 164:1 (C.I. Solvent Red 164 manufactured without o-toluidene), C.I. Solvent Red 165 (C.I. Red 164 shaded with C.I. Solvent Orange 98), C.I. Solvent Red 19(T) (mix of 1-[[2-methyl-4-[(2-methylphenyl)azo]phenyl]azo]-N-alkylnaphthalen-2-amines and 1-({2-methyl-4-[(2-methylphenyl)diazenyl]phenyl}diazenyl)-2-naphthol), C.I. Solvent Red 19(E) (N-(2-ethylhexyl)-1-({2-methyl-4-[(2-methylphenyl)diazenyl]phenyl}diazenyl)-1,2-dihydronaphthalen-2-amine), C.I. Solvent Red 175 (Dinaptho[1,2,3,-cd:1′,2′,3′-Im]perylene-9,18-dione,dodecyl derivatives), C.I. Solvent Blue 98 (9,10-Anthracenedione, 1,4-Mixed Alkyl-Amino), C.I. Solvent Blue 79 (9,10-Anthracenedione, 1,4-Mixed Alkyl-Alkoxy Amino), C.I. Solvent Yellow 175 (4-[((di)alkyl phenyl) diazenyl]-2-[((di)alkyl phenyl) diazenyl]benzene-1,3-diol and derivatives), C.I. Solvent Yellow CAS no. 97660-72-5 (3H-Pyrazol-3-one, 2,4-dihydro-5-methyl-2-phenyl-, 4-[(alkylphenyl)azo]derivatives), C.I. Solvent Yellow 107 (2,2′-((3,3′-Dialkyl(1,1′-biphenyl)-4,4′-diyl)bis(azo))bis(4-alkylphenols)), C.I. Solvent Orange 98 (1,3-Benzenediol, 2,4-bis(alkylphenyl-azo)), C.I. Solvent Blue 99 (2-methoxy-5-methyl-4-{phenyl-azo}-benzamine diazotized and azo coupled to N-(alkylphenyl)-2 naphthalenamine), C.I. Solvent Red ((4-(phenyl-azo)-benzamine and mono-tetramethylated derivatives diazotized and coupled to N-(2-ethyl-hexyl)-2-naphthalenamine)), C.I. Solvent Red ((2-Naphthaleneamine-N-2-(ethyl-hexyl-1-{{2-methylphenylazo}-phenyl}azo} and mixtures thereof), C.I. Solvent Green 33 (9,10-Anthracenedione-1,4-(dodecylphenyl)), and mixtures thereof.

Clause 6. The composition of any preceding clause, wherein the dye compound is selected from the group consisting of: C.I. Solvent Red 164, C.I. Solvent Red 164:1, C.I. Solvent Red 19(T), C.I. Solvent Red 19(E), C.I. Solvent Red 175, C.I. Solvent Blue 98, C.I. Solvent Blue 79, C.I. Solvent Yellow 175, C.I. Solvent Yellow CAS no. 97660-72-5, C.I. Solvent Yellow 107, C.I. Solvent Orange 98, and mixtures thereof.

Clause 7. The composition according to any previous clause, wherein the dye compound is present in the composition in an amount of at least about 23 wt. %, at least about 25 wt. %, at least about 30 wt. %, or at least about 35 wt. %.

Clause 8. The composition according to any previous clause, wherein the dye compound is present in the composition in an amount of at most about 50 wt. %, at most about 55 wt. %, at most about 60 wt. %, or at most about 65 wt. %.

Clause 9. The composition according to any previous clause, wherein the dye compound is present in the composition from about 30 to about 65 wt. %.

Clause 10. The composition according to any previous clause, wherein the solvent exhibits a flash point above at least 65° C., above at least 70° C., or above at least 75° C., when measured according to the open cup method at standard pressure (1 ATM).

Clause 11. The composition according to any previous clause, wherein the solvent is present in the composition in an amount of at least about 10 wt. %, at least about 20 wt. %, at least about 25 wt. %, at least about 30 wt. %, or at least about 35 wt. %.

Clause 12. The composition according to any previous clause, wherein the solvent is present in the composition in an amount of at most about 77 wt. %, at most about 75 wt. %, at most about 70 wt. %, at most about 60 wt. %, or at most about 40 wt. %.

Clause 13. The composition according to any previous clause, wherein the solvent is present in the composition from about 35 wt. % to about 70 wt. %.

Clause 14. The composition of any preceding clause, further comprising a cosolvent.

Clause 15. The composition according to the immediately preceding clause, wherein the cosolvent is of formula III:

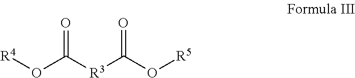

wherein R³ is a C₁ to C₅ dienyl group; and R⁴ and R⁵ are each independently a C₁ to C₄ alkyl group.

Clause 16. The composition according to any of to, wherein the cosolvent is a dibasic ester or mix of dibasic esters.

Clause 17. The composition according to any of to, wherein the cosolvent is selected from the group consisting of dimethyl glutarate, dimethyl adipate, and dimethyl succinate, and mixtures thereof.

Clause 18. The composition according to, wherein the cosolvent further includes one or more of xylenes (mixed and single isomers), high flash aromatic solvents, hydro-treated light and middle naphthenic distillates, hydro-treated mineral oils, alcohols (straight and branched chain), glycols, glycol ethers, mineral spirits, soy oil esters, and NMP (i.e., N-Methyl Pyrrolidone).

Clause 19. The composition according to, wherein the cosolvent further cosolvent comprises an aryl benzoate of Formula IV:

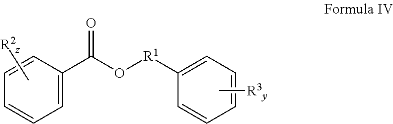

wherein R¹ is a C₁ to C₄ alkyl group;
R² is F, Cl, Br, C₁₋₄-alkyl, —NH—CO—H, —NH—CO—C₁₋₄alkyl, —NH₂, —NH—C₁₋₄alkyl, or NO₂ and z is 0, 1, 2, 3, or 4; and
R³ is F, Cl, Br, C₁₋₄-alkyl, —NH—CO—H, —NH—CO—C₁₋₄alkyl, —NH₂, —NH—C₁₋₄alkyl, or NO₂ and y is 0, 1, 2, 3, or 4.

Clause 20. The composition according to, wherein the cosolvent further includes benzyl benzoate, phenethyl benzoate, and mixtures thereof.

Clause 21. The composition according to any of to, wherein the cosolvent is present in the composition in an amount of at least about 0.1 wt. %, at least about 2 wt. %, at least about 5 wt. %, at least about 7 wt. %, or at least about 10 wt. %.

Clause 22. The composition according to any of to, wherein the cosolvent is present in the composition in an amount of at most about 35 wt. %, at most about 30 wt. %, at most about 25 wt. %, at most about 20 wt. %, or at most about 12 wt. %.

Clause 23. The composition according to any of to, wherein the cosolvent is present in the composition from about 0.1 wt. % to about 25 wt. %.

Clause 24. The composition according to any of to, wherein the cosolvent has a flash point of above at least 65° C., above at least 70° C., or above at least 75° C., when measured according to the open cup method at standard pressure (1 ATM).

Clause 25. The composition of any preceding clause, further comprising an additive or a reaction byproduct, or a mixture thereof.

Clause 26. The composition according to the immediately preceding clause, wherein the additive is present in the composition at less than about 10 wt. %, less than about 5 wt. %, less than about 2 wt. %, less than about 1 wt. %, or less than about 0.1 wt. %, and is selected from the group consisting of surfactants, dispersants, and mixtures thereof.

Clause 27. The composition according to any of to, wherein the reaction byproduct is present in the composition at less than about 15 wt. %, less than about 10 wt. %, less than about 5 wt. %, or less than about 2 wt. %, and the reaction byproduct is a compound that is produced in the production of or a reaction forming the dye compound.

Clause 28. The composition according to any preceding clause, wherein the composition includes less than 10 wt. % of a combined sum of any xylenes (mixed and single isomers), high flash aromatic solvents, hydro-treated light and middle naphthenic distillates, hydro-treated mineral oils, alcohols (straight and branched chain), glycols, glycol ethers, mineral spirits, soy oil esters, and NMP.

Clause 29. The composition according to any preceding clause, wherein the composition includes less than 5 wt. % of a combined sum of any xylenes (mixed and single isomers), high flash aromatic solvents, hydro-treated light and middle naphthenic distillates, hydro-treated mineral oils, alcohols (straight and branched chain), glycols, glycol ethers, mineral spirits, soy oil esters, and NMP.

Clause 30. The composition according to any preceding clause, wherein the composition is substantially free of each of xylenes (mixed and single isomers), high flash aromatic solvents, hydro-treated light and middle naphthenic distillates, and hydro-treated mineral oils.

Clause 31. The composition according to any preceding clause, wherein the composition is substantially free of any photosensitive polymer, includes no more than 0.1 wt. % photosensitive polymer, includes no more than 0.01 wt. % photosensitive polymer, or is entirely free of any photosensitive polymer.

Clause 32. The composition according to any previous clause, wherein the composition exhibits a viscosity of at least 5 centipoise and at most 500 centipoise, at least 5 centipoise and at most 450 centipoise, or at least 5 centipoise and at most 415 centipoise when measured at 20±1° C. and standard pressure (1 ATM).

Clause 33. The composition according to any previous clause, wherein the composition exhibits a viscosity of at least 5 centipoise, at least 10 centipoise, at least 15 centipoise, or at least 20 centipoise, when measured at 20±1° C. and standard pressure (1 ATM).

Clause 34. The composition according to any previous clause, wherein the composition exhibits a viscosity of at most 30 centipoise, at most 50 centipoise, at most 60 centipoise, or at most 80 centipoise, when measured at 20±1° C. and standard pressure (1 ATM).

Clause 35. The composition according to any previous clause, wherein the composition exhibits a viscosity of from 10 to 50 centipoise, when measured at 20±1° C. and standard pressure (1 ATM).

Clause 36. The composition according to any previous clause, wherein the composition exhibits a standardized viscosity increase of at most 40 centipoise, at most 50 centipoise, at most 75 centipoise, or at most 120 centipoise, wherein the standardized viscosity increase is the difference between the viscosity of the composition at 25±1° C. and standard pressure (1 ATM) and the viscosity of the composition at 5±1° C. and standard pressure (1 ATM) in centipoise, each viscosity measure is conducted on a digital viscometer with 18-34 mm spindle, and the 25±1° C. measurement is made at 50 RPM while the 5±1° C. measurement is made at 10 RPM.

Clause 37. A composition consisting essentially of:
(i) A solvent having Formula I;

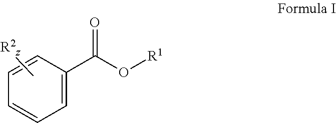

wherein R¹ is a C₁ to C₆ alkyl group; R² is F, Cl, Br, C₁₋₄-alkyl, —NH—CO—H, —NH—CO—C₁₋₄alkyl, —NH₂, —NH—C₁₋₄-alkyl, or NO₂; and z is 0, 1, 2, 3, or 4;
(ii) a dye compound selected from the group consisting of compounds of Formulas A, B, C, D, E, F, and G and mixtures thereof:

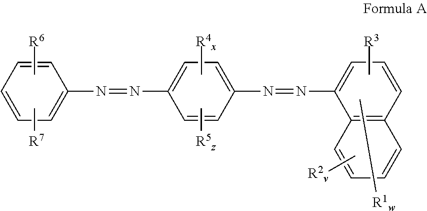

wherein R¹_{w} and R²ᵥ are each independently a C₆ to C₁₁ alkyl group; R³ is selected from hydroxyl and —NHR⁸, and any R⁸ is a C₇ to C₁₄ alkyl group; R⁴ₓ and R⁵_{z} is each independently a C₁ to C₄ alkyl group; R⁶ and R⁷ is each independently selected from hydrogen or a C₁ to C₄ alkyl group; each of v, w, x, and z may be 0 or 1; x+z>1; and if w+v=0, R³ is —NHR⁸, and any R⁸ is a C₇ to C₁₄ alkyl group;

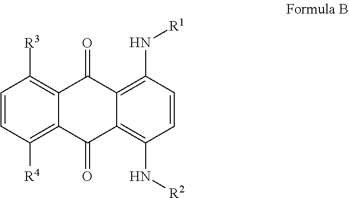

wherein each of R¹ and R² is independently selected from the group consisting of C₁ to C₁₂ alkyl and —C₁-C₅—O—C₁-C₁₂; each R³ and R⁴ is independently H or hydroxyl; and at least one of R¹ and R² contains five or more carbon atoms;

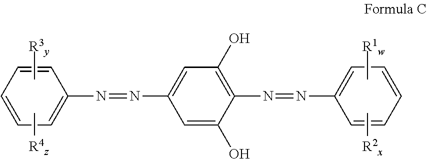

wherein each of R¹_{w} and R²ₓ is independently a C₇ to C₁₄ alkyl group; each of R³_{y} and R⁴_{z} is independently a C₁ to C₁₄ alkyl group; each of w, x, y, and z may be 0 or 1, and w+x+y+z≥2;

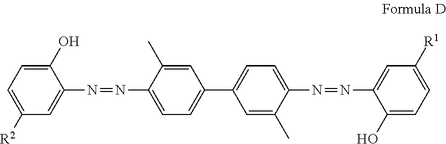

wherein each of R¹ and R² is independently a C₇ to C₁₅ alkyl group;

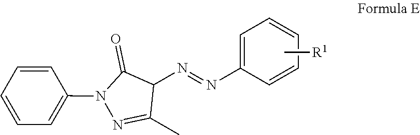

wherein R¹ is a C₇ to C₁₅ alkyl group;

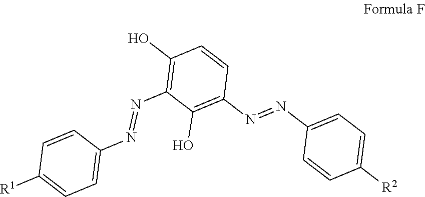

wherein R¹ and R² are each independently a C₇ to C₁₅ alkyl group; and

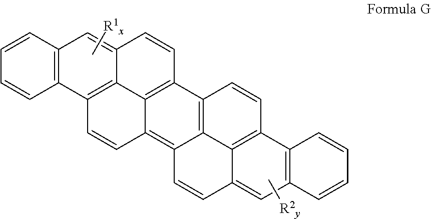

wherein R¹ₓ and R²_{y} are each independently a C₇ to C₁₅ alkyl group; x and y may each be 0 or 1 and x+y>1;
(iii) from 0 to 10 wt. % of one or more additives;
(iv) from 0 to 30 wt. % of a cosolvent; and
(v) from 0 to 10 wt. % of a reaction byproduct, wherein the reaction byproduct is a compound that is produced in the production of or a reaction forming the dye compound.

Clause 38. The composition according to, wherein the solvent is of Formula II:

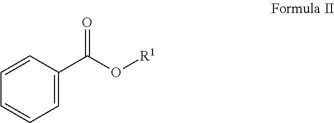

wherein R¹ is C₁ to C₆ alkyl.

Clause 39. The composition of any of to the immediately preceding clause, wherein the solvent is selected from the group consisting of methyl benzoate, ethyl benzoate, isopropyl benzoate, propyl benzoate, butyl benzoate, isopentyl benzoate, and mixtures thereof.

Clause 40. The composition of any of to the immediately preceding clause, wherein the solvent is ethyl benzoate.

Clause 41. The composition of any of to the immediately preceding clause, wherein the dye compound is selected from the group consisting of: C.I. Solvent Red 164 (4-(phenylazo)-benzamine and mono-tetramethylated derivatives diazotized and coupled to alkylated 2-Naphthalenol), C.I. Solvent Red 164:1 (C.I. Solvent Red 164 manufactured without o-toluidene), C.I. Solvent Red 165 (C.I. Red 164 shaded with C.I. Solvent Orange 98), C.I. Solvent Red 19(T) (mix of 1-[[2-methyl-4-[(2-methylphenyl)azo]phenyl]azo]-N-alkylnaphthalen-2-amines and 1-({2-methyl-4-[(2-methylphenyl)diazenyl]phenyl}diazenyl)-2-naphthol), C.I. Solvent Red 19(E) (N-(2-ethylhexyl)-1-({2-methyl-4-[(2-methylphenyl)diazenyl]phenyl}diazenyl)-1,2-dihydronaphthalen-2-amine), C.I. Solvent Red 175 (Dinaptho[1,2,3,-cd:1′,2′,3′-Im]perylene-9,18-dione,dodecyl derivatives), C.I. Solvent Blue 98 (9,10-Anthracenedione, 1,4-Mixed Alkyl-Amino), C.I. Solvent Blue 79 (9,10-Anthracenedione, 1,4-Mixed Alkyl-Alkoxy Amino), C.I. Solvent Yellow 175 (4-[((di)alkyl phenyl) diazenyl]-2-[((di)alkyl phenyl) diazenyl]benzene-1,3-diol and derivatives), C.I. Solvent Yellow CAS no. 97660-72-5 (3H-Pyrazol-3-one, 2,4-dihydro-5-methyl-2-phenyl-, 4-[(alkylphenyl)azo]derivatives), C.I. Solvent Yellow 107 (2,2′-((3,3′-Dialkyl(1,1′-biphenyl)-4,4′-diyl)bis(azo))bis(4-alkylphenols)), C.I. Solvent Orange 98 (1,3-Benzenediol, 2,4-bis(alkylphenyl-azo)), C.I. Solvent Blue 99 (2-methoxy-5-methyl-4-{phenyl-azo}-benzamine diazotized and azo coupled to N-(alkylphenyl)-2 naphthalenamine), C.I. Solvent Red ((4-(phenyl-azo)-benzamine and mono-tetramethylated derivatives diazotized and coupled to N-(2-ethyl-hexyl)-2-naphthalenamine)), C.I. Solvent Red ((2-Naphthaleneamine-N-2-(ethyl-hexyl-1-{{2-methylphenylazo}-phenyl}azo} and mixtures thereof), C.I. Solvent Green 33 (9,10-Anthracenedione-1,4-(dodecylphenyl)), and mixtures thereof.

Clause 42. The composition of any of to the immediately preceding clause, wherein the dye compound is selected from the group consisting of: C.I. Solvent Red 164, C.I. Solvent Red 164:1, C.I. Solvent Red 19(T), C.I. Solvent Red 19(E), C.I. Solvent Red 175, C.I. Solvent Blue 98, C.I. Solvent Blue 79, C.I. Solvent Yellow 175, C.I. Solvent Yellow CAS no. 97660-72-5, C.I. Solvent Yellow 107, C.I. Solvent Orange 98, and mixtures thereof.

Clause 43. The composition according to any of to the immediately preceding clause, wherein the dye compound is present in the composition in an amount of at least about 23 wt. %, at least about 25 wt. %, at least about 30 wt. %, or at least about 35 wt. %.

Clause 44. The composition according to any of to the immediately preceding clause, wherein the dye compound is present in the composition in an amount of at most about 50 wt. %, at most about 55 wt. %, at most about 60 wt. %, or at most about 65 wt. %.

Clause 45. The composition according to any of to the immediately preceding clause, wherein the dye compound is present in the composition from about 30 to about 65 wt. %.

Clause 46. The composition according to any of to the immediately preceding clause, wherein the solvent exhibits a flash point above at least 65° C., above at least 70° C., or above at least 75° C., when measured according to the open cup method at standard pressure (1 ATM).

Clause 47. The composition according to any of to the immediately preceding clause, wherein the solvent is present in the composition in an amount of at least about 10 wt. %, at least about 20 wt. %, at least about 25 wt. %, at least about 30 wt. %, or at least about 35 wt. %.

Clause 48. The composition according to any of to the immediately preceding clause, wherein the solvent is present in the composition in an amount of at most about 77 wt. %, at most about 75 wt. %, at most about 70 wt. %, at most about 60 wt. %, or at most about 40 wt. %.

Clause 49. The composition according to any of to the immediately preceding clause, wherein the solvent is present in the composition from about 35 wt. % to about 70 wt. %.

Clause 50. The composition according to any of to the immediately preceding clause, wherein the cosolvent is of formula III:

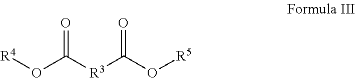

wherein R³ is a C₁ to C₅ dienyl group; and R⁴ and R⁵ are each independently a C₁ to C₄ alkyl group.

Clause 51. The composition according to any of to the immediately preceding clause, wherein the cosolvent is a dibasic ester or mix of dibasic esters.

Clause 52. The composition according to any of to the immediately preceding clause, wherein the cosolvent is selected from the group consisting of dimethyl glutarate, dimethyl adipate, and dimethyl succinate, and mixtures thereof.

Clause 53. The composition according to any of to the immediately preceding clause, wherein the cosolvent includes one or more of xylenes (mixed and single isomers), high flash aromatic solvents, hydro-treated light and middle naphthenic distillates, hydro-treated mineral oils, alcohols (straight and branched chain), glycols, glycol ethers, mineral spirits, soy oil esters, and NMP (i.e., N-Methyl Pyrrolidone).

Clause 54. The composition according to, wherein the cosolvent further cosolvent comprises an aryl benzoate of Formula IV:

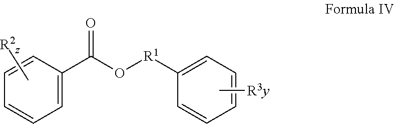

wherein R¹ is a C₁ to C₄ alkyl group;
R² is F, Cl, Br, C₁₋₄-alkyl, —NH—CO—H, —NH—CO—C₁₋₄alkyl, —NH₂, —NH—C₁₋₄alkyl, or NO₂ and z is 0, 1, 2, 3, or 4; and
R³ is F, Cl, Br, C₁₋₄-alkyl, —NH—CO—H, —NH—CO—C₁₋₄alkyl, —NH₂, —NH—C₁₋₄alkyl, or NO₂ and y is 0, 1, 2, 3, or 4.

Clause 55. The composition according to, wherein the cosolvent further includes benzyl benzoate, phenethyl benzoate, and mixtures thereof.

Clause 56. The composition according to any of to the immediately preceding clause, wherein the cosolvent is present in the composition in an amount of at least about 0.1 wt. %, at least about 2 wt. %, at least about 5 wt. %, or at least about 7 wt. %.

Clause 57. The composition according to any of to the immediately preceding clause, wherein the cosolvent has a flash point of above at least 65° C., above at least 70° C., or above at least 75° C., when measured according to the open cup method at standard pressure (1 ATM).

Clause 58. The composition according to the immediately preceding clause, wherein the additive is present in the composition at less than about 5 wt. %, less than about 2 wt. %, less than about 1 wt. %, or less than about 0.1 wt. %, and is selected from the group consisting of surfactants, dispersants, and mixtures thereof.

Clause 59. The composition according to any of to the immediately preceding clause, wherein the reaction byproduct is present in the composition at less than about 5 wt. %, or less than about 2 wt. %, and the reaction byproduct is a compound that is produced in the production of or a reaction forming the dye compound.

Clause 60. The composition according to any of to the immediately preceding clause, wherein the composition includes less than 5 wt. % of a combined sum of any xylenes (mixed and single isomers), high flash aromatic solvents, hydro-treated light and middle naphthenic distillates, hydro-treated mineral oils, alcohols (straight and branched chain), glycols, glycol ethers, mineral spirits, soy oil esters, and NMP.

Clause 61. The composition according to any of to the immediately preceding clause, wherein the composition is substantially free of each of xylenes (mixed and single isomers), high flash aromatic solvents, hydro-treated light and middle naphthenic distillates, and hydro-treated mineral oils.

Clause 62. The composition according to any previous clause, wherein the composition exhibits a standardized viscosity increase of at most 40 centipoise, at most 50 centipoise, at most 75 centipoise, or at most 120 centipoise, wherein the standardized viscosity increase is the difference between the viscosity of the composition at 25±1° C. and standard pressure (1 ATM) and the viscosity of the composition at 5±1° C. and standard pressure (1 ATM) in centipoise, each viscosity measure is conducted on a digital viscometer with 18-34 mm spindle, and the 25±1° C. measurement is made at 50 RPM while the 5±1° C. measurement is made at 10 RPM.

Clause 63. The composition according to any of to the immediately preceding clause, wherein the composition exhibits a viscosity of at least 5 centipoise, at least 10 centipoise, at least 15 centipoise, or at least 20 centipoise, when measured at 20±1° C. and standard pressure (1 ATM).

Clause 64. The composition according to any of to the immediately preceding clause, wherein the composition exhibits a viscosity of at most 40 centipoise, at most 45 centipoise, at most 50 centipoise, or at most 60 centipoise, when measured at 20±1° C. and standard pressure (1 ATM).

Clause 65. The composition according to any of to the immediately preceding clause, wherein the composition exhibits a viscosity of from 10 to 50 centipoise, when measured at 20±1° C. and standard pressure (1 ATM).

Clause 66. A composition according to any previous clause for use in producing colored smoke for aerial or aerobatic displays.

Clause 67. A method for generating colored smokes for aerobatic displays, wherein the method comprises the steps of:
feeding a composition according to any previous clause into the efflux of a jet in flight; or
heating a composition according to any previous clause in a self-contained smoke generation device that is on-board an aircraft and expelling the resulting smoke from the self-contained generation device.

Clause 68. A composition according to any of Clause 1 to for use in conducting liquid penetrant testing for non-destructive testing.

Clause 69. Use of a dye formulation for producing colored smoke for aerial or aerobatic displays, wherein the dye formulation is as provided in any of Clause 1 to.

Clause 70. A composition according to any of Clause 1 to for use in tagging a substrate for identification.

Clause 71. A method for tagging a substrate for identification comprising contacting the composition according to any of Clause 1 to with the substrate in amounts suitable to identify the substrate.

Clause 72. A method for coloring a substrate comprising contacting the composition according to any of Clause 1 to with the substrate.

Clause 73. A composition according to any of Clause 1 to for use in coloring of a substrate.

Clause 74. A surface coated with the composition according to any of Clause 1 to.

Clause 75. A kit comprising:
(i) a first component comprising a solvent as defined in any one of Clause 1 to; and
(ii) a second component comprising a dye compound as defined in any one of Clause 1 to.

Clause 76. The kit of the immediately preceding clause, further comprising at least one additive, at least one reaction byproduct, or both.

Clause 77. The kit of the immediately preceding clause, wherein the at least one additive, if present, and the at least one reaction byproduct, if present, may each be present in the first component, the second component, or both.

Clause 78. The kit of, further comprising a third component, and wherein the at least one additive, if present, and the at least one reaction byproduct, if present, may each be present in the first component, the second component, the third component, or some combination of any of the first, second, and third component.

Clause 79. A kit comprising:
(iii) a first component comprising a solvent as defined in any one of Clause 1 to and a dye compound as defined in any one of Clause 1 to; and
(iv) a second component comprising a developer chemical for drawing out the first component from a surface defect on a surface.

Clause 80. The kit of the immediately preceding clause, further comprising at least one of a cosolvent, an additive, a reaction byproduct, or mixtures thereof.

Clause 81. The kit of the immediately preceding clause, wherein the additive, if present, and the cosolvent, if present, may each be present in the first component, the second component, or both, and the reaction byproduct, if present, is present in the first component.

### EXAMPLES

The following examples further illustrate the subject matter described above but, of course, should not be construed as in any way limiting the scope thereof.

Viscosity was assessed over a range of temperatures to assess viscosity behavior in relatively high concentration dyes. Each sample was prepared by combining dye compounds with the indicated solvents in the relative amounts indicated in Table 1 (wt. % indicates the percent of the total dye formulation sample weight).

Sample viscosity was assessed using a BROOKFIELD DV1 Digital Viscometer, Model M14 type (available from AMETEK, Inc., Berwin, Pennsylvania, USA). Samples were analyzed using a Small Sample Adapter with a jacketed glycol/water temperature bath provided to the shell of the Small Sample Adapter to precisely control temperature. For each sample, the temperature was programmed starting at 25° C., and the glycol/water loop programmatically adjusted the temperature. Once the temperature stabilized, the viscosity measurement was taken. The temperature was subsequently reduced in steps of 5° C., and viscosity measurements were taken at each temperature indicated in Table 1 once temperature stabilized at the new setpoint.

TABLE 1

| | | Temperature | Viscosity |
|---|---|---|---|
| | RPM | (° C.) | (cP) |
| Sample 1 | | | |
| Composition: | | | |
| Commercially | 50 | 25 | 45.18 |
| available as | | | |
| Automate ™ | | | |
| Blue 8AHF Liquid | | | |
| Dye (available from | | | |
| Dow Chemical Co., | | | |
| Midland, MI, USA) | | | |
| C.I. Solvent Blue | 50 | 20 | 61.05 |
| 98 (39-44 wt. %) | | | |
| Aromatic 200 | | | |
| Naphthalene | | | |
| Depleted (48-55 wt. | | | |
| %; CAS No. | | | |
| 64742-94-5) | | | |
| Dipropyleneglycol | 50 | 15 | 82.95 |
| monomethyl | | | |
| ether (3-5 wt. %; | | | |
| CAS No. 34590- | | | |
| 94-8) | | | |
| Naphthalene | 20 | 10 | 115.8 |
| (0.0001-0.6 wt. %; | | | |
| CAS No. 91-20-3) | | | |
| Ethylhexylamine | | | |
| (0.9841 wt. %; | | | |
| CAS No. 104-75-6) | | | |
| Diphenyl (0.0001- | 10 | 5 | 168 |
| 10.0 wt. %; | | | |
| CAS No. 92-52-4) | | | |
| Sample 2 | | | |
| Composition: | 50 | 25 | 14.88 |
| Solvent Blue 98 (50 wt. %) | 50 | 20 | 18 |
| Ethyl benzoate (50 wt. %) | 50 | 15 | 22.32 |
| (greater than 99% purity; CAS | 50 | 10 | 28.2 |
| No. 93-89-0) | 10 | 5 | 36.92 |

When compared to an existing commercial system (Sample 1), specifically one in which Aromatic 200 Naphthalene Depleted is used as the primary solvent, the inventive, Sample 2 system surprisingly demonstrates a lower viscosity at a higher color strength (higher concentration of C.I. Solvent Blue 98), across all temperatures tested. The viscosity of the Sample 2 system further shows less variation across the temperature range with viscosity increasing less at lower temperatures, relative to Sample 1. Thus, Sample 2 provides a more consistent temperature-viscosity operating window.

Preferred embodiments of the subject matter of this application are described herein. Variations of those preferred embodiments may become apparent to those of ordinary skill in the art upon reading the foregoing description. The inventors expect skilled artisans to employ such variations as appropriate, and the inventors intend for the subject matter described herein to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

What is claimed is:

1. A composition comprising:
(i) A solvent having Formula I; 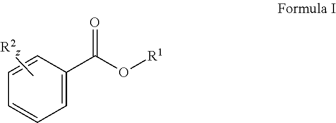
wherein R¹ is a C₁ to C₆ alkyl group; R² is F, Cl, Br, C₁₋₄-alkyl, —NH—CO—H, —NH—CO—C₁₋₄alkyl, —NH₂, —NH—C₁₋₄-alkyl, or NO₂; and z is 0, 1, 2, 3, or 4; and
(ii) a dye compound selected from the group consisting of compounds of formulas A, B, C, D, E, F, and G and mixtures thereof: 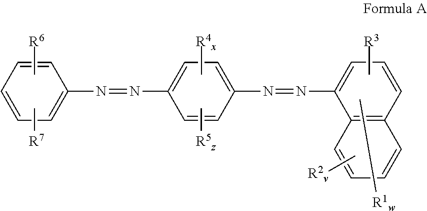
wherein R¹_{w} and R²ᵥ are each independently a C₆ to C₁₁ alkyl group; R³ is selected from hydroxyl and —NHR⁸, and any R⁸ is a C₇ to C₁₄ alkyl group; R⁴ₓ and R⁵_{z} is each independently a C₁ to C₄ alkyl group; R⁶ and R⁷ is each independently selected from hydrogen or a C₁ to C₄ alkyl group; each of v, w, x, and z may be 0 or 1; x+z≥1; and if w+v=0, R³ is —NHR⁸, and any R⁸ is a C₇ to C₁₄ alkyl group; 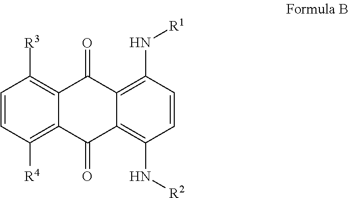
wherein each of R¹ and R² is independently selected from the group consisting of C₁ to C₁₂ alkyl and —C₁-C₅—O—C₁-C₁₂; each R³ and R⁴ is independently H or hydroxyl; and at least one of R¹ and R² contains five or more carbon atoms; 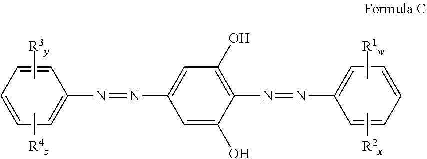
wherein each of R¹_{w} and R²ₓ is independently a C₇ to C₁₄ alkyl group; each of R³_{y} and R⁴_{z} is independently a C₁ to C₁₄ alkyl group; each of w, x, y, and z may be 0 or 1, and w+x+y+z≥2; 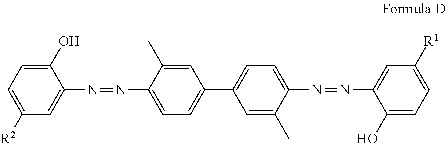
wherein each of R¹ and R² is independently a C₇ to C₁₅ alkyl group; 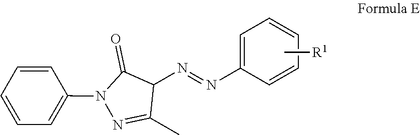
wherein R¹ is a C₇ to C₁₅ alkyl group; 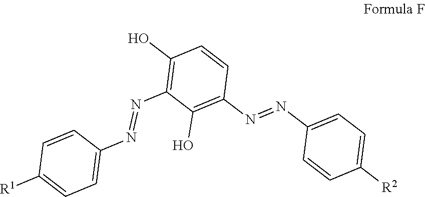
wherein R¹ and R² are each independently a C₇ to C₁₅ alkyl group; and 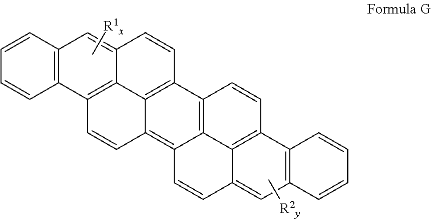
wherein R¹ₓ and R²_{y} are each independently a C₇ to C₁₅ alkyl group; x and y may each be 0 or 1 and x+y≥1.

2. The composition of claim 1, wherein the solvent is of Formula II: 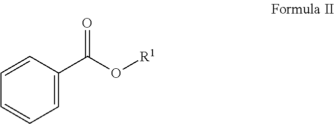
wherein R¹ is C₁ to C₆ alkyl.

3. The composition of claim 1, wherein the solvent is selected from the group consisting of methyl benzoate, ethyl benzoate, isopropyl benzoate, propyl benzoate, butyl benzoate, isopentyl benzoate, and mixtures thereof.

4. The composition according to claim 3, wherein the solvent is ethyl benzoate.

5. The composition according to claim 1, wherein the dye compound is selected from the group consisting of: C.I. Solvent Red 164, C.I. Solvent Red 164:1 (manufactured without o-toluidene), C.I. Solvent Red 165 (C.I. Red 164 shaded with C.I. Solvent Orange 98), C.I. Solvent Red 19(T) (mix of 1-[[2-methyl-4-[(2-methylphenyl)azo]phenyl]azo]-N-alkylnaphthalen-2-amines and 1-({2-methyl-4-[(2-methylphenyl)diazenyl]phenyl}diazenyl)-2-naphthol), C.I. Solvent Red 19(E) (N-(2-ethylhexyl)-1-({2-methyl-4-[(2-methylphenyl)diazenyl]phenyl}diazenyl)-1,2-dihydronaphthalen-2-amine), C.I. Solvent Red 175 (Dinaptho[1,2,3,-cd:1′,2′,3′-Im]perylene-9,18-dione,dodecyl derivatives), C.I. Solvent Blue 98 (9,10-Anthracenedione, 1,4-Mixed Alkyl-Amino), C.I. Solvent Blue 79 (9,10-Anthracenedione, 1,4-Mixed Alkyl-Alkoxy Amino), C.I. Solvent Yellow 175 (4-[((di)alkyl phenyl) diazenyl]-2-[((di)alkyl phenyl) diazenyl]benzene-1,3-diol and derivatives), C.I. Solvent Yellow CAS no. 97660-72-5 (3H-Pyrazol-3-one, 2,4-dihydro-5-methyl-2-phenyl-, 4-[(alkylphenyl)azo]derivatives), C.I. Solvent Yellow 107 (2,2′-((3,3′-Dialkyl(1,1′-biphenyl)-4,4′-diyl)bis(azo))bis(4-alkylphenols)), C.I. Solvent Orange 98 (1,3-Benzenediol, 2,4-bis(alkylphenyl-azo)), and mixtures thereof.

6. The composition according to claim 1, further comprising a cosolvent.

7. The composition according to claim 6, wherein the cosolvent is of formula III: 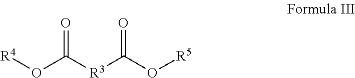
wherein R³ is a C₂ to C₅ dienyl group; and R⁴ and R⁵ are each independently a C₁ to C₄ alkyl group.

8. The composition according to claim, wherein the cosolvent is selected from the group consisting of dimethyl glutarate, dimethyl adipate, and dimethyl succinate, and mixtures thereof.

9. The composition according to claim, wherein the cosolvent is present in the composition from about 0.1 wt. % to about 25 wt. %.

10. The composition according to claim 9, wherein the cosolvent comprises an aryl benzoate of Formula IV: 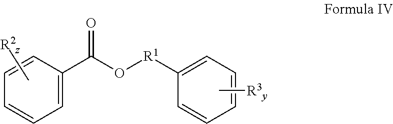
wherein R¹ is a C₁ to C₄ alkyl group;
R² is F, Cl, Br, C₁₋₄-alkyl, —NH—CO—H, —NH—CO—C₁₋₄alkyl, —NH₂, —NH—C₁₋₄alkyl, or NO₂ and z is 0, 1, 2, 3, or 4; and
R³ is F, Cl, Br, C₁₋₄-alkyl, —NH—CO—H, —NH—CO—C₁₋₄alkyl, —NH₂, —NH—C₁₋₄alkyl, or NO₂ and y is 0, 1, 2, 3, or 4.

11. The composition according to claim 9, wherein the cosolvent is selected from the group consisting of benzyl benzoate, phenethyl benzoate, and mixtures thereof.

12. The composition according to claim 1, further comprising an additive or a reaction byproduct, or a mixture thereof,
wherein the additive, when present, is present in the composition at less than about 10 wt. % and is selected from the group consisting of a surfactant, dispersant, and mixtures thereof, and
wherein the reaction byproduct, when present, is present in the composition at less than about 10 wt. %, and the reaction byproduct is a compound that is produced in the production of or a reaction forming the dye compound.

13. The composition according to claim, wherein the composition is substantially free of each of xylenes, naphthalene depleted, and hydrotreated mineral oil solvents.

14. The composition according to claim 1, wherein the composition is substantially free of any photosensitive polymer.

15. The composition according to claim 1, wherein the composition exhibits a viscosity of from 10 to 50 centipoise, when measured at 20±1° C. and standard pressure (1 ATM) on a digital viscometer with 18 mm spindle at 50 RPM.

16. The composition according to claim 1, wherein the dye compound is present in the composition from about 30 to about 65 wt. %.

17. The composition according to claim 1, wherein the solvent exhibits a flash point of at least 65° C. when measured according to the open cup method at standard pressure (1 ATM).

18. A composition according to claim 1 for use in producing colored smoke for aerial or aerobatic displays.

19. A method for generating colored smokes for aerobatic displays, wherein the method comprises the steps of:
feeding a composition according to claim 1 into the efflux of a jet in flight; or
heating a composition according to claim 1 in self-contained smoke generation device that is on-board an aircraft and expelling the resulting smoke from the self-contained generation device.

20. A composition according to claim 1 for use in conducting liquid penetrant testing for non-destructive testing.
